(19) United States
(12) Patent Application Publication
(10) Pub. No.: US 2026/0341861 A1
(43) Pub. Date: Oct. 29, 2026

(54) SECONDARY BATTERY, METHOD OF HEAT PRESSING SECONDARY BATTERY, AND APPARATUS FOR HEAT PRESSING SECONDARY BATTERY

(71) Applicant: SAMSUNG SDI CO., LTD., Yongin-si (KR)

(72) Inventors: Jun Sik KIM, Yongin-si (KR); Seomi YANG, Yongin-si (KR)

(21) Appl. No.: 19/567,630

(22) Filed: Mar. 16, 2026

(30) Foreign Application Priority Data
Apr. 25, 2025 (KR) 10-2025-0054884

(51) Int. Cl. H01M 50/169; H01M 50/103; H01M 50/119

(52) U.S. Cl. CPC H01M 50/169; H01M 50/103; H01M 50/119

(57) ABSTRACT

A secondary battery may include an electrode assembly including a first electrode, a second electrode, and a separator disposed between the first electrode and the second electrode and a case. The case may include a body having one open surface to accommodate the electrode assembly and a cover sealing the one open surface of the body, the cover pressing and fixing the electrode assembly. A pressing portion recessed toward the electrode assembly may be formed at a bottom of the body or a surface of the cover.

### CROSS-REFERENCE TO RELATED APPLICATION

This application claims priority under 35 U.S.C. § 119(a)-(d) of Korean Patent Application No. 10-2025-0054884, filed in the Korean Intellectual Property Office on Apr. 25, 2025, the entire contents of which are hereby incorporated by reference.

### BACKGROUND

### Field

The present disclosure relates to a secondary battery, a method of heat pressing the secondary battery, and an apparatus for heat pressing the secondary battery.

### Description of Related Art

Due to non-uniform pressure applied to an assembly, there may be little contact between an electrode and a separator, which may lead to local current concentration and overheating. In addition, the non-uniform pressure may cause deformation and damage to the electrode, which may result in an internal short-circuit, may result in battery swelling, and, in severe cases, may create safety issues.

The above information disclosed in this Background section is for the enhancement of understanding of the background of the present disclosure, and, therefore, it may contain information that does not constitute related (or prior) art.

### SUMMARY

The present disclosure aims to provide a secondary battery, a method of heat pressing the secondary battery, and an apparatus for heat pressing the secondary battery to solve the problems described above.

However, the technical problem to be solved by the present disclosure is not limited to the above-described problems, and other problems not mentioned in the present disclosures, and aspects and features of the present disclosure that would address such problems, will be clearly understood by those skilled in the art from the descriptions below.

A secondary battery according to some embodiments of the present disclosure may include an electrode assembly including a first electrode, a second electrode, and a separator disposed between the first electrode and the second electrode and a case. The case may include a body having one open surface to accommodate the electrode assembly and a cover sealing the one open surface of the body, the cover pressing and fixing the electrode assembly. A pressing portion recessed toward the electrode assembly may be formed at a bottom of the body or a surface of the cover.

In some embodiments, a material of the case may include stainless use steel.

In some embodiments, a thickness of the case may be from about 0.05 mm to about 0.2 mm.

In some embodiments, the electrode assembly may be a stacked-type electrode assembly formed by alternately stacking a first unit cell, in which the first electrode and the separator may be stacked, and a second unit cell, in which the second electrode and the separator may be stacked. A planar size of the pressing portion may be greater than a planar size of a smallest electrode of a group consisting of the first electrode and the second electrode, and may be less than a planar size of a plane delimited by borders of an inner surface of the body.

In some embodiments, a direction in which the case presses the electrode assembly may be a stacking direction of the first electrode, the separator, and the second electrode.

In some embodiments, the electrode assembly may be a wound-type electrode assembly including an upper planar portion, a lower planar portion, and a curved portion connected to a side surface of the upper planar portion and the lower planar portion. A planar size of the pressing portion may be greater than the upper planar portion or the lower planar portion and may be less than a planar size of a plane delimited by borders of an inner surface of the body.

In some embodiments, a direction in which the case presses the electrode assembly may be a stacking direction of the first electrode, the separator, and the second electrode, which may be stacked between the upper planar portion and the lower planar portion.

In some embodiments, the pressing portion may include a first pressing portion formed on the bottom of the body and a second pressing portion formed on the surface of the cover. A minimum length in a Z-direction between the first pressing portion and the second pressing portion may be from about 90% to about 99% of a maximum length in the Z-direction between the bottom of the body and an outer surface of the cover.

In some embodiments, the electrode assembly further may include an adhesive layer including a material of polyvinylidene fluoride series or a material of acrylate series positioned between the separator and the first electrode or between the separator and the second electrode.

In some embodiments, the adhesive layer further may include a ceramic material.

In some embodiments, the electrode assembly further may include a ceramic layer between the adhesive layer and the separator.

A method of heat pressing a secondary battery according to some embodiments of the present disclosure may include preparing a first heat pressing plate and a second heat pressing plate by spacing the first heat pressing plate and the second heat pressing plate apart from each other by a predetermined distance and by attaching a buffer pad onto a surface of the first heat pressing plate or a surface of the second heat pressing plate, arranging a secondary battery between the first heat pressing plate and the second heat pressing plate, and heating and pressing the secondary battery with the first heat pressing plate and the second heat pressing plate.

In some embodiments, the method further includes, before arranging the secondary battery between the first heat pressing plate and the second heat pressing plate, attaching a cell pad, having a size corresponding to an electrode assembly, to a first longitudinal side wall or a second longitudinal side wall of a case of the secondary battery, the first longitudinal side wall and the second longitudinal side wall facing each other.

In some embodiments, the method further may include providing the electrode assembly so that the electrode assembly may be a stacked-type electrode assembly formed by alternately stacking a first unit cell, in which a first electrode and a separator may be stacked, and a second unit cell, in which a second electrode and the separator may be stacked and providing the cell pad such that a planar size of the cell pad may be greater than a planar size of a smallest electrode of a group consisting of the first electrode and the second electrode and may be less than a planar size of a plane delimited by borders of an inner surface of the case.

In some embodiments, the method further may include providing the electrode assembly so that the electrode assembly may be a wound-type electrode assembly including an upper planar portion, a lower planar portion, and a curved portion connected to side surfaces of the upper planar portion and the lower planar portion and providing the cell pad so that a planar size of the cell pad may be greater than the upper planar portion or the lower planar portion and may be less than a planar size of a plane delimited by borders of an inner surface of the case.

In some embodiments, the method further may include providing an electrode assembly that may be a stacked-type electrode assembly formed by alternately stacking a first unit cell, in which a first electrode and a separator may be stacked, and a second unit cell, in which a second electrode and the separator may be stacked and configuring a planar size of the buffer pad to be greater than a planar size of a smallest electrode of a group consisting of the first electrode and the second electrode and to be less than a planar size of a plane delimited by borders of an inner surface of a case of the secondary battery.

In some embodiments, the method further may include providing an electrode assembly that may be a wound-type electrode assembly including an upper planar portion, a lower planar portion, and a curved portion connected to side surfaces of the upper planar portion and the lower planar portion and configuring a planar size of the buffer pad to be greater than the upper planar portion or the lower planar portion and to be less than a planar size of a plane delimited by borders of an inner surface of a case of the secondary battery.

A heat pressing apparatus of a secondary battery according to some embodiments of the present disclosure may include a first heat pressing plate including a first heater; a second heat pressing plate including a second heater and being spaced apart from a bottom of the first heat pressing plate by a predetermined distance; a buffer pad arranged on a surface of the first heat pressing plate or a surface of the second heat pressing plate; and a driving part pressing a case of a secondary battery by moving the first heat pressing plate or the second heat pressing plate toward the case, which may be between the first heat pressing plate and the second heat pressing plate.

In some embodiments, an electrode assembly may be a stacked-type electrode assembly formed by alternately stacking a first unit cell, in which a first electrode and a separator may be stacked, and a second unit cell, in which a second electrode and the separator may be stacked. A planar size of the buffer pad may be greater than a planar size of a smallest electrode of a group consisting of the first electrode and the second electrode and may be less than a planer size of a plane delimited by borders of an inner surface of the case.

In some embodiments, an electrode assembly may be a wound-type electrode assembly including an upper planar portion, a lower planar portion, and a curved portion connected to side surfaces of the upper planar portion and the lower planar portion. A planar size of the buffer pad may be greater than the upper planar portion or the lower planar portion and may be less than a planar size of a plane delimited by borders of an inner surface of the case.

According to some embodiments of the present disclosure, structural rigidity of a secondary battery may be improved.

According to some embodiments of the present disclosure, an energy density per unit volume or per unit weight a secondary battery may increase.

According to some embodiments of the present disclosure, an electrode assembly may be uniformly pressed and/or heated during a manufacturing process of a secondary battery, thereby enhancing lifespan characteristics, performance, and safety of the secondary battery.

However, aspects and features of the present disclosure are not limited to the descriptions above, and other aspects and features not mentioned above will be clearly understood by a person skilled in the art from the detailed description, the claims, and the drawings of the present disclosure.

### BRIEF DESCRIPTION OF DRAWINGS

The following drawings illustrate some embodiments of the present disclosure and further describe aspects and features of the present disclosure, together with the detailed description of the present disclosure. However, the present disclosure should not be construed as being limited to the drawings.

FIG. 1 is an exploded perspective view illustrating a structure of a secondary battery according to some embodiments of the present disclosure.

FIG. 2 is a top view illustrating a secondary battery according to some embodiments of the present disclosure.

FIG. 3 is a side cross-sectional view illustrating a secondary battery according to some embodiments of the present disclosure.

FIG. 4 is a side cross-sectional view illustrating a secondary battery according to some embodiments of the present disclosure.

FIG. 5 is a cross-sectional view of part of an electrode assembly according to some embodiments of the present disclosure.

FIG. 6 is a cross-sectional view of part of an electrode assembly according to some embodiments of the present disclosure.

FIG. 7 is a flow chart illustrating a method of heat pressing a secondary battery according to some embodiments of the present disclosure.

FIGS. 8 to 11 are views illustrating a method of heat pressing a secondary battery using an apparatus for heat pressing a secondary battery according to some embodiments of the present disclosure.

FIG. 12 is a graph illustrating a thickness reduction ratio of a secondary battery according to pressing pressure conditions of a heat pressing method according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements or layers may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” and “upper,” may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lesser numerical limitations subsumed therein, and any minimum numerical limitation recited in this specification is intended to include all greater numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements and/or features as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for the purpose of describing embodiments of the present disclosure and are not intended to limit the present disclosure.

According to some embodiments of the present disclosure, sizes of layers and areas are illustrated in the drawings may be exaggerated for clarity of explanation. The sizes in the drawings are only for ease of explanation, but the present disclosure is not limited thereto. Like reference numerals in the drawings denote like elements throughout the specification.

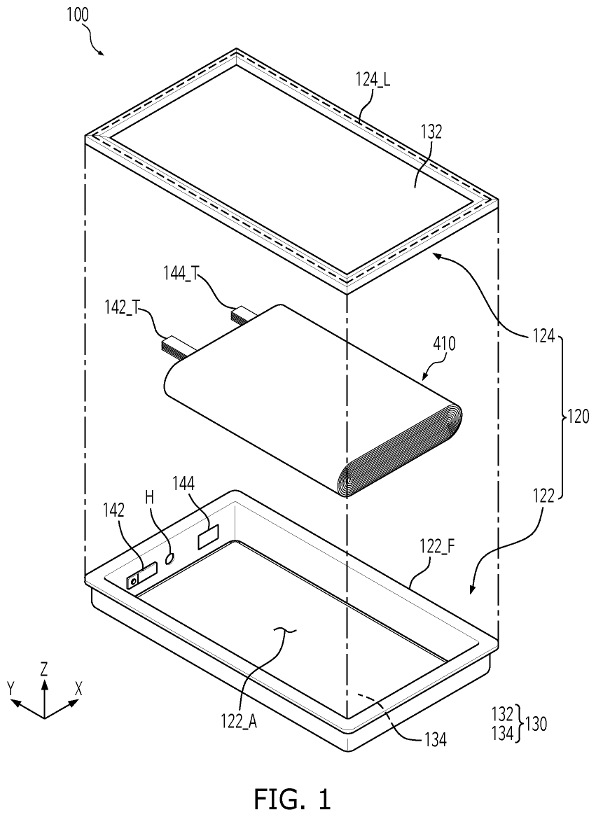

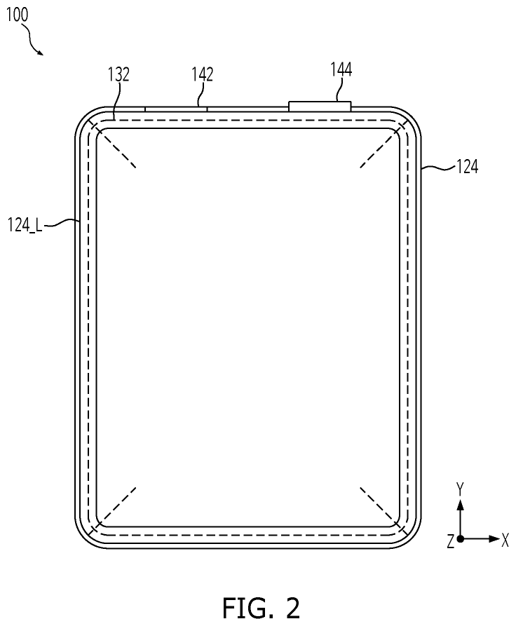

FIG. 1 is an exploded perspective view illustrating the structure of a secondary battery according to some embodiments of the present disclosure. FIG. 2 is a top view illustrating a secondary battery according to some embodiments of the present disclosure.

A secondary battery 100 according to some embodiments of the present disclosure may include an electrode assembly 410, an electrolyte (not shown), and a case 120 configured to accommodate the electrode assembly 410 and an electrolyte.

The electrode assembly 410 may be formed by winding or stacking a stacked body including a first electrode, a separator, and a second electrode each formed having a geometry of a thin plate or a thin film. As shown in FIG. 1, when the electrode assembly 410 is a wound stacked body, a winding axis may be parallel to the length direction (Y-axis direction) of the case 120. However, a geometry of the electrode assembly 410 is not limited thereto, and the electrode assembly 410 may be a stacked-type electrode assembly instead of a wound-type electrode assembly. In some embodiments, the electrode assembly 410 may be a z-stack electrode assembly into which the first electrode and the second electrode are inserted on both sides of a separator bent in a z-stack configuration. In some embodiments, the electrode assembly 410 may be one or more assemblies stacked so that longitudinal sides are adjacent to each other and accommodated inside the case 120. The number of electrode assemblies 410 accommodated inside the case 120 is not limited in the present disclosure. The first electrode of the electrode assembly 410 may function as a negative electrode, and the second electrode may function as a positive electrode. Reversely, the first electrode may function as a positive electrode, and the second electrode may function as a negative electrode.

The first electrode may be formed by applying a first electrode active material, such as graphite or carbon to a first electrode current collector formed of a metal foil, such as copper, a copper alloy, nickel, or a nickel alloy, and may include a first non-coated part, where the first electrode active material is not applied. A first electrode tab 142_T formed on one side surface of the electrode assembly 410 may be connected to the first non-coated part to function as a passage for a current flow between the first electrode and the first current collector. According to some embodiments, when the first electrode is manufactured, the first electrode tab 142_T may be cut to protrude toward one side or may protrude toward one side more than a separator without an additional cutting process.

The second electrode may be formed by applying a second electrode active material, such as a transition metal oxide to a second electrode current collector formed of a metal foil such as aluminum or an aluminum alloy and may include a second non-coated part of which the second electrode active material is not applied. A second electrode tab 144_T formed on one side surface of the electrode assembly 410 may be connected to the second non-coated part to function as a passage for a current flow between the second electrode and the second current collector. According to some embodiments, when the second electrode is manufactured, the second electrode tab 144_T may protrude to the other side by cutting or may protrude toward the other side more than a separator without an additional cutting process.

According to some embodiments, the first electrode tab may be disposed on the left end side of the electrode assembly 410, and the second electrode tab may be disposed on the right end side of the electrode assembly 410 or may be disposed on one side surface in the same direction. The left side and the right side are indicated for ease of explanation with respect to the electrode assembly 410 shown in FIG. 1, and the positions of the left and right sides may change when rotated left-right or up-down. As shown in FIG. 1, the first electrode tab 142_T and the second electrode tab 144_T may be disposed on one side surface in the same direction of the electrode assembly 410, so that a first electrode terminal 142 electrically connected to the first electrode tab 142_T, and a second electrode terminal 144 electrically connected to the second electrode tab 144_T may be formed on one side surface in the same direction of the case 120.

The case 120 may form the overall exterior of the secondary battery 100 and may include a body 122 configured to accommodate the electrode assembly 410 with one open surface, and a cover 124 configured to seal the one open surface of the body 122. The case 120 may include a pressing portion 130 recessed toward the electrode assembly 410 on at least one of the bottom of the body 122 or may include one side of the cover 124 of the body 122 to press and to fix the electrode assembly 140.

Referring to FIG. 1, according to some embodiments, the pressing portion 130 may include a second pressing portion 134 recessed in a positive z direction on the bottom of the body 122, and/or a first pressing portion 132 recessed in a negative z direction on one side of the cover 124.

According to some embodiments, the material of the case 120 may include stainless steel (i.e., stainless use steel). The body 122 and the cover 124 may be made of the same material. The material of the case 120 may include various series of stainless use steel materials depending on the size or use of the secondary battery 100. The material of the case 120 may be austenitic stainless steel, which is an alloy of carbon 0.05% or less, chromium 15% or more, and nickel 8% or more. The case 120 made of austenitic stainless steel may have strong formability, weldability, and corrosion resistance.

When the case is made of aluminum or the case has aluminum foil inside the case and a polymer layer outside the case, the case may be manufactured to have a predetermined thickness or more to ensure the structural rigidity of the case at a predetermined level or greater. In contrast, a case made of stainless steel may have the improved structural rigidity compared to a case made of aluminum or a case formed by stacking aluminum foil and a polymer layer, so that the case may be manufactured to be thinner. Accordingly, a case made of stainless steel may have a greater energy density per unit volume or per unit weight of a secondary battery than a case made of aluminum or a case formed by stacking aluminum foil and a polymer layer.

In a pouch-type secondary battery, when the case is manufactured of aluminum, which has excellent formability but relatively weak mechanical rigidity, the thickness may be manufactured to be approximately 0.3 mm or more to ensure structural rigidity. In some embodiments, when the case is manufactured by disposing the polymer layer on both sides of aluminum foil in the pouch-type secondary battery, and the case is manufactured to be approximately 0.1 mm or less, the structural rigidity of the case may be weak, the secondary battery may be damaged or broken during handling, use, or replacement. When the case made of stainless steel is used, stainless steel may have a greater mechanical strength than aluminum, so even though the thickness of the case is designed to be thinner, the structural rigidity of the secondary battery may be ensured at the same level.

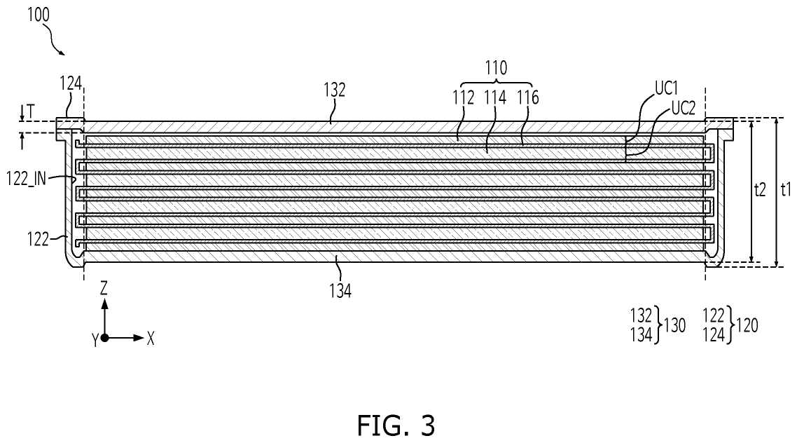

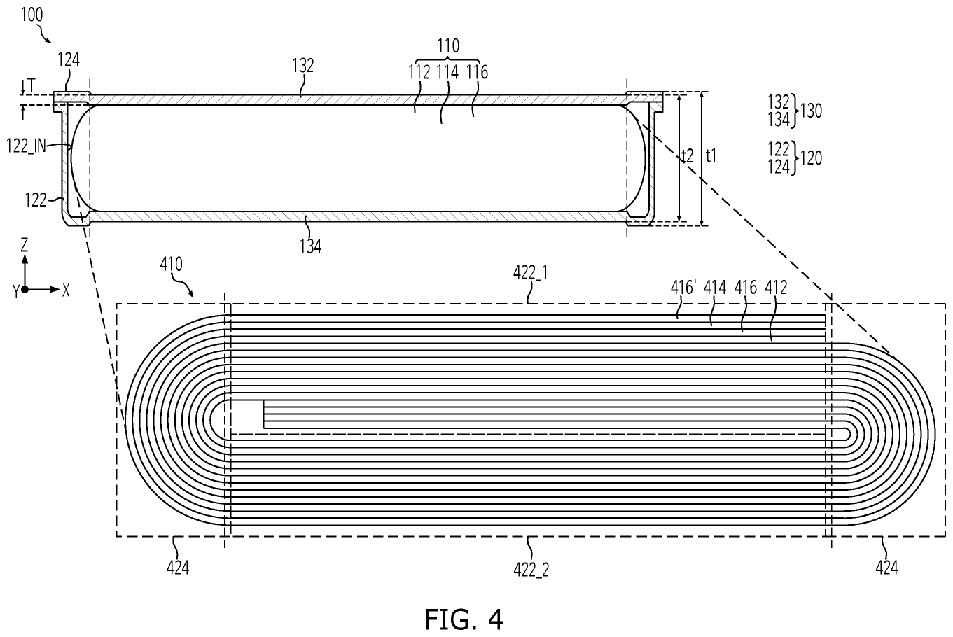

According to some embodiments, when the case 120 is manufactured by using stainless steel, the thickness of the case 120 may be designed to be about 0.2 mm or less, about 0.1 mm or less, from about 0.05 mm to about 0.2 mm, or from about 0.05 mm to about 0.1 mm. According to the present disclosure, the thickness of the case 120 (e.g., T of FIG. 3 or T of FIG. 4 described below) may refer to the cross-sectional thickness of the outer material that forms the case 120. Specifically, the thickness of the case 120 may indicate the thickness of the body 122 or the thickness of the cover 124. The thickness of the body 122 may indicate the cross-section thickness of the outer material that forms the body 122 (e.g., the cross-sectional thickness of the bottom of the body 122 or the cross-sectional thickness of one of 4 (four) sides of the body 122), and the thickness of the cover 124 (T of FIG. 3 and T of FIG. 4 described below) may indicate the cross-sectional thickness of the outer material that forms the cover 124.

The body 122 may include an accommodating part 122_A having an end open to accommodate the electrode assembly 410. The accommodating part 122_A of the body 122 may be formed to have an inner space for accommodating the electrode assembly 410 by a press processing. The planar geometry of the accommodating part 122_A of the case 120 may be formed in a square geometry, but the planar geometry of the accommodating part 122_A of the case 120 is not limited thereto.

The body 122 may include a flange part 122_F that extends from a periphery of one open end of the accommodating part 122_A, and the cover 124 may be coupled to the flange part 122_F to seal one open end of the accommodating part 122_A.

Specifically, the cover 124 may be formed as a flat plate that is coupled to the flange part 122_F of the body 122 to seal the open end of the accommodating part 122_A. The cover 124 may be formed as a flat plate having a size to cover the flange part 122_F , thereby performing surface contact with the flange part 122_F. The lower surface of the cover 124 may perform surface contact with the upper surface of the flange part 122_F. As the flange part 122_F is coupled to the cover 124, the body 122 and the cover 124 may be formed as an integrated structure.

In the case 120, the flange part 122_F and the cover 124,which has a geometry corresponding to the flange part 122_F, may be coupled along a coupling line 124_L. The coupling line 124_L may indicate an interface between the flange part 122_F and the cover 124 to seal the accommodating part 122_A. The coupling line 124_L may include a welding part where the flange part 122_F is welded to the cover 124 through a laser welding device. Additionally or alternatively, the coupling line 124_L may include an adhesion part where the flange part 122_F is bonded to the cover 124 by an adhesive. The coupling line 124_L may be formed along the edge of the cover 124 and the flange part 122_F.

The case 120 may further include the first electrode terminal 142 arranged on one side surface of the body 122 and electrically connected to the first electrode of the electrode assembly 410, and the second electrode terminal 144 arranged on one side surface of the body 122 and electrically connected to the second electrode of the electrode assembly 410.

An electrolyte injection hole H may be a through hole for inserting an electrolyte of the secondary battery into the inside of the case 120 and may connect the accommodating part 122_A, which is sealed by bonding the body 122 to the cover 124. The electrolyte injection hole H may be sealed by a stopper (not shown) after the electrolyte is injected.

Locations of the electrolyte injection hole H and the stopper for sealing the electrolyte injection hole H may be arranged on one side surface of the body 122 or the cover 12. Specifically, in FIG. 1, the electrolyte injection hole H is illustrated as being formed on one side surface of the body 122 to be interposed between the first electrode terminal 142 and the second electrode terminal 144, but the present disclosure is not limited thereto. The electrolyte injection hole H and the stopper for sealing the electrolyte injection hole H may be arranged at the center of the flat plate that forms the cover 124, or on another side of the body 122.

Referring to FIG. 2, the cover 124 of the case may include the coupling line 124_L formed on the cover 124, and the first pressing portion 132. The first pressing portion 132 may be recessed in the direction toward the electrode assembly accommodated inside the case (Z-direction), thereby pressing and fixing the electrode assembly. The coupling line 124_L may be arranged at the outer edge of the first pressing portion 132 on the cover 124.

Referring to FIG. 2, the first electrode terminal 142 may be electrically connected to the first electrode of the electrode assembly and may be exposed to the outside of the case from one side surface of the body (e.g., 122 of FIG. 1) of the case. The second electrode terminal 144 may be electrically connected to the second electrode of the electrode assembly and may be exposed to the outside of the case on one side surface of the body (e.g., 122 of FIG. 1). The first electrode terminal 142 and the second electrode terminal 144 may be exposed to the outside of the case on the same side of the body (e.g., 122 of FIG. 1). The first electrode terminal 142 may be electrically connected to the case 120 and may have a same polarity as the first electrode, and the second electrode terminal 144 may be insulated from the case 120 to have a same polarity of the second electrode.

The first electrode terminal 142 and the second electrode terminal 144 may be made of a metal having excellent electrical conductivity or an alloy including the metal having excellent electrical conductivity. Aluminum or an alloy thereof may be used for a positive electrode, and nickel or a nickel-copper alloy may be used for a negative electrode.

FIG. 3 is a side cross-sectional view illustrating a secondary battery according to some embodiments of the present disclosure. The pressing portion 130 may include the second pressing portion 134 formed on the bottom of the body 122 and the first pressing portion 132 formed on one surface of the cover 124. However, the present disclosure is not limited thereto, and the pressing portion 130 may indicate one of the second pressing portion 134 formed on the bottom of the body 122 or the first pressing portion 132 formed on one surface of the cover 124.

Referring to FIG. 3, the electrode assembly 110 may be a stacked-type electrode assembly formed by alternately stacking a first unit cell UC1 made by stacking a first electrode 112 and a separator 116, and a second unit cell UC2 made by stacking a second electrode 114 and the separator 116.

The separator of the first unit cell UC1 and the separator of the second unit cell UC2 may be the same separator or a separate separator. As shown in FIG. 3, when the separator 116 of the first unit cell UC1 and the separator 116 of the second unit cell UC2 are an integrated separator, the electrode assembly 110 may be a z-stack electrode assembly in which the first electrode 112 and the second electrode 114 are inserted on both sides of the separator 116 bent with a z-stack configuration.

When the electrode assembly 110 is a stacked-type electrode assembly, a size of a plane of each of the first pressing portion 132 and the second pressing portion 134 may be greater than one of the first electrode 112 and the second electrode 114 of which planar size is smallest and may be less than the planar size defined by an inner surface 122_IN of the body. As shown in FIG. 3, the planar size of each of the first pressing portion 132 and the second pressing portion 134 may be arranged greater than the second electrode 114 to press the area where the first electrode 112 overlaps the second electrode 114. Therefore, a uniform electrical chemical reaction between interfaces of the first electrode 112 and the second electrode 114 of the secondary battery 100 may be induced. Therefore, the inner resistance of the secondary battery 100 may be reduced, and lifespan characteristics of the secondary battery may be improved.

A direction in which the first pressing portion 132 formed on one surface of the cover 124 and the second pressing portion 134 formed on the bottom of the body 122 press the accommodated electrode assembly 110 may be a stacking direction (Z-direction) of the first electrode 112, the separator 116, and the second electrode 114. The one surface of the cover 124 and the bottom of the body 122 may form an outer surface of the case 120, and an inner surface opposite to the outer surface may contact the electrode assembly 110. The surface opposite to the one surface of the cover 124 where the first pressing portion 132 is formed and the surface opposite to the bottom of the body 122 where the second pressing portion 134 is formed may contact and press the electrode assembly 110 as shown in FIG. 3.

A minimum length t2 between the first pressing portion 132 and the second pressing portion 134 may be from about 90% to about 99% of a maximum length t1 between the bottom of the body 122 and the outer surface of the cover 124. Through the design of the recessed depth of the pressing portion 130, pressing and heating may be performed without damage to the electrode assembly 110 accommodated inside the case 120 during the manufacturing process of the secondary battery 100. A thickness T of the case 120 may be from about 0.05 mm to about 0.2 mm. The thickness T of the case 120 may be formed less than or equal to about 0.2 mm, thereby increasing an energy density per volume of the secondary battery.

FIG. 4 is a side cross-sectional view illustrating a secondary battery according to some embodiments of the present disclosure. Particularly, FIG. 4 is an enlarged view illustrating an electrode assembly.

An electrode assembly 410 may be a wound-type electrode assembly including an upper planar portion 422_1, a lower planar portion 422_2, and a curved portion 424 connected to side surfaces of the upper planar portion 422_1 and the lower planar portion 422_2. The stacked body in which a first electrode 412, a separator 416, a second electrode 414, and a separator 416′ are sequentially stacked may be wound to form a wound-type electrode assembly including the upper planar portion 422_1, the lower planar portion 422_2, and the curved portion 424 connected to the side surfaces of the upper planar portion 422_1 and the lower planar portion 422_2.

When the electrode assembly 410 is a wound-type electrode assembly, the planar size of each of the first pressing portion 132 and the second pressing portion 134 may be greater than at least one of the upper planar portion 422_1 and the lower planar portion 422_2 and may be less than the planar size of a plane delimited by borders of an inner surface 122_IN of the body. As illustrated in FIG. 4, the planar size of each of the first pressing portion 132 and the second pressing portion 134 may be greater than the size of the upper planar portion 422_1 or the lower planar portion 422_2 on an XY plane so that all areas where the first electrode 412 overlaps the second electrode 414 within the upper planar portion 422_1 and the lower planar portion 422_2 may be pressed. Thereby, a uniform electrochemical reaction may be induced between the interfaces of the first electrode 412 and the second electrode 414 of the secondary battery 100. Therefore, the internal resistance of the secondary battery 100 may be reduced and the life characteristics may be improved.

The direction in which the first pressing portion 132 formed on one surface of the cover 124 and the second pressing portion 134 formed on the bottom of the body 122 press the accommodated electrode assembly 410 may be a stacking direction (Z-direction) of the first electrode 142, the separators 416 and 416′ and the second electrode 414 between the upper planar portion 422_1 and the lower planar portion 422_2.

A minimum length t2 between the first pressing portion 132 and the second pressing portion 134 may be 90% to 99% of the maximum length t1 between the bottom of the body 122 and the outer surface of the cover 124. Through the design of the recessed depth of the pressing portion 130, pressing and heating may be performed without damaging the electrode assembly 410 accommodated inside the case 120 during the manufacturing process of the secondary battery 100. The thickness T of the case 120 may be from about 0.05 mm to about 0.2 mm. The thickness T of the case 120 may be about 0.2 mm or less, thereby increasing the energy density per volume of the secondary battery.

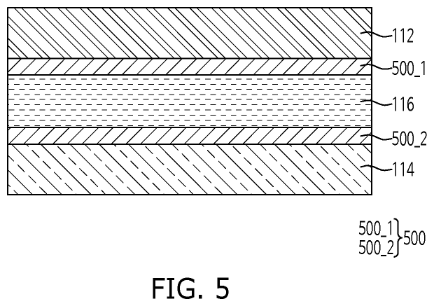

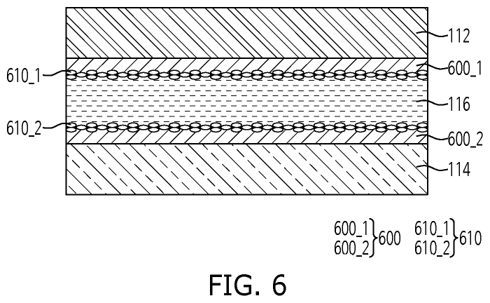

FIG. 5 is a cross-sectional view of part of an electrode assembly according to some embodiments of the present disclosure. FIG. 6 is a cross-sectional view of part of an electrode assembly according to some embodiments of the present disclosure. The cross-sections of FIG. 5 and FIG. 6 are substantially the same as part of the cross-section described above.

The electrode assembly according to some embodiments may further include an adhesive layer 500 disposed between the separator 116 and the first electrode 112 or between the separator 116 and the second electrode 114. The adhesive layer 500 may include a first adhesive layer 500_1 arranged between the first electrode 112 and the separator 116 and may include a second adhesive layer 500_2 arranged between the second electrode 114 and the separator 116.

The separator 116 may be a porous film including a porous polyolefin series, polyethylene series, polypropylene series, or a composite material thereof. The adhesive layer 500 may include the material of a polyvinylidene fluoride (PVDF) series or an acrylate series.

The first adhesive layer 500_1 or the second adhesive layer 500_2 may further include ceramic. Accordingly, the heat resistance of the electrode assembly pressed or heated by the pressing portion may be enhanced.

Referring to FIG. 6, the electrode assembly may further include a ceramic layer 610 arranged between an adhesive layer 600 and the separator 116. The ceramic layer 610 may be an additional functional layer formed of ceramic. The adhesive layer 600 may be the same or similar to the adhesive layer 500 described with reference to FIG. 5, and the adhesive layer 600 may include a ceramic material or may not include a ceramic material.

The ceramic layer 610 may include a first ceramic layer 610_1 arranged between a first adhesive layer 600_1 and the separator 116 and a second ceramic layer 610_2 arranged between a second adhesive layer 600_2 and the separator 116. The ceramic layer 610 may indicate one of the first ceramic layer 610_1 or the second ceramic layer 610_2.

As described above, the electrode assembly pressed by the pressing portion may include an adhesive layer and a ceramic layer, which induces uniform electrical chemical reactions between the interfaces of the first electrode 112 and the second electrode 114. Therefore, safety, lifespan characteristics, and performance of the secondary battery may be improved.

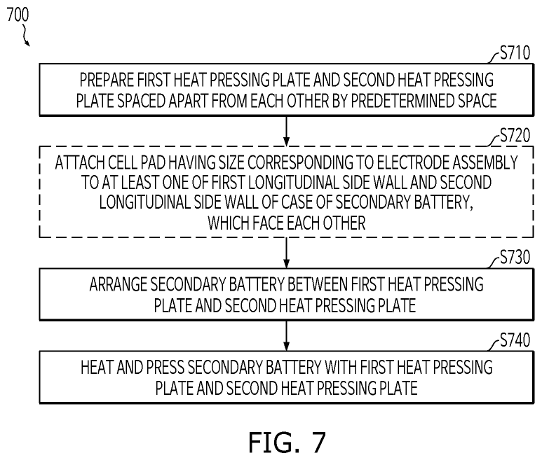

FIG. 7 is a flow chart illustrating a method of heat pressing a secondary battery according to some embodiments of the present disclosure.

The heat press method of the secondary battery may be part of a method of manufacturing the secondary battery 100 described with reference to FIGS. 1 to 6. The secondary battery 100 may be manufactured by performing a formation process including a heat press method, such as a heat press method described below. In addition, the heat pressing method of the secondary battery 100 may be performed by a heat pressing apparatus, such as a heat pressing apparatus described below.

A heat pressing method 700 may be initiated by preparing a first heat pressing plate and a second heat pressing plate spaced apart from each other at a predetermined distance in step 710. A buffer pad may be attached to one of the first heat pressing plate or the second heat pressing plate. The size of the buffer pad may vary depending on the size of an electrode assembly of the secondary battery and may be attached or coupled to the first heat pressing plate or the second heat pressing plate.

A step of arranging a secondary battery between the first heat pressing plate and the secondary heat pressing plate may be performed as step S730. The secondary battery may be a secondary battery that accommodates an electrode assembly that includes an adhesive layer or a ceramic layer as described above with reference to FIG. 5 and FIG. 6. Even though the heat pressing method 700 is performed, high heat resistance may prevent damage or deterioration of the electrode assembly.

The step of heating and pressing the secondary battery by the first heat pressing plate or the second heat pressing plate may be performed in step S740.

Before the step of arranging the secondary battery between the first heat pressing plate and the second heat pressing plate in step 730, the heat pressing method 700 may further include a step of attaching a cell pad, having a size corresponding to the electrode assembly, to at least one of a first longitudinal side wall and a second longitudinal side wall of the case of the secondary battery, which face each other as step S720.

In step S710 of arranging the first heat pressing plate and the second heat pressing plate spaced apart from each other at a predetermined space, a buffer pad may be detached from one surface of the first heat pressing plate and the second heat pressing plate.

The flowchart of FIG. 7 and the above description are merely exemplary to explain the present disclosure, and the scope of the present disclosure is not limited to the flowchart of FIG. 7 and the above descriptions. One or more steps in the flowchart and the above descriptions may be added, changed, and/or deleted; the order of one or more steps may be changed; and/or one or more steps may be performed simultaneously.

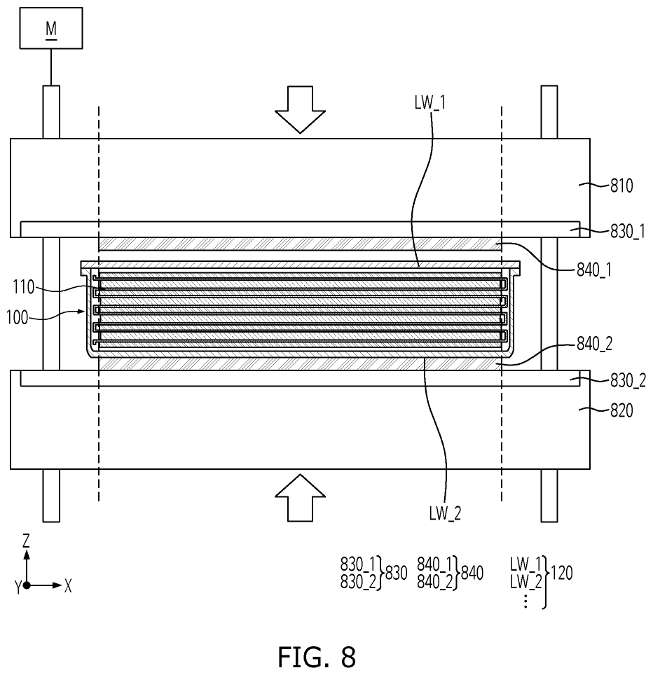

FIGS. 8 to 11 are views illustrating a method of heat pressing a secondary battery using an apparatus for heat pressing a secondary battery according to some embodiments of the present disclosure.

Referring to FIG. 8 to FIG. 11, an electrode assembly 110 is illustrated as being a stacked-type electrode assembly described with reference to FIG. 2, but the present disclosure is not limited thereto. For example, the electrode assembly 110 may instead be a wound-type electrode assembly. The heat pressing apparatus and a method of the secondary battery may be used during a heat press charge-discharge process.

After the injecting electrode assembly into the inside of the case, sealing, and injecting an electrolyte are completed, the secondary battery may be aged so that an electrolyte may be sufficiently impregnated into the electrode assembly. The heat press charge-discharge process may be performed, and the heat press charge-discharge process may be part of the formation process of the secondary battery.

Referring to FIG. 8, according to some embodiments of the present disclosure, a heat pressing apparatus of the secondary battery may include a first heat pressing plate 810 including a first heater 830_1, a second heat pressing plate 820 arranged spaced apart from the bottom of the first heat pressing plate 810 at a predetermined distance and including a second heater 830_2, a buffer pad 840, and a driving part M.

The first heat pressing plate 810 and the second heat pressing plate 820 may be flat and spaced apart by a predetermined distance to press the secondary battery interposed between the first heat pressing plate 810 and the second heat pressing plate 820. The first heat pressing plate 810 and the second heat pressing plate 820 may press and heat the secondary battery by the driving part M. The driving part M may include a linear motor or an actuator configured to drive at least one of the first heat pressing plate 810 and the second heat pressing plate 820 to move in a vertical direction (e.g., Z-direction). Additionally, the driving part M may include a heat source or a heat power configured to provide heat energy or power to at least one of the first heater 830_1 and the second heater 830_2.

The first heater 830_1, being arranged close to the bottom of the first heat pressing plate 810, may transmit heat into the inside of the secondary battery 100 through a first longitudinal side wall LW_1 of the secondary battery that contacts the bottom of the first heater 830_1. The second heater 830_2 arranged to be close to the top of the second heat pressing plate 820 may transmit heat into the inside of the secondary battery 100 through a second longitudinal side wall LW_2 of the secondary battery that contacts the top of the second heater 830_2. The first longitudinal side wall LW_1 may indicate the area before the pressing portion is formed on one surface of the cover described above with reference to FIG. 1 to FIG. 4. The second longitudinal side wall LW_2 may indicate the area before the pressing portion is formed on the bottom of the body that is described with reference to FIG. 1 to FIG. 4.

The driving part M may be configured to press the case of the secondary battery 100 by moving at least one of the first heat pressing plate 810 and the second heat pressing plate 820 toward the case of the secondary battery 100 disposed between the first heat pressing plate 810 and the second heat pressing plate 820. The driving part M may be configured to lower the first heat pressing plate 810 and/or to raise the second heat pressing plate 820.

A buffer pad 840 may be arranged on one surface of at least one of the first heat pressing plate 810 or the second heat pressing plate 820. Specifically, the buffer pad 840 may be arranged on at least one of the bottom of the first heat pressing plate 810 or the top of the second heat pressing plate 820. The buffer pad 840 may have a greater planar size than whichever of the first electrode and the second electrode that has a smallest planar size and may be less than the planar size of a plane delimited by borders of the inner surface of the case 120 so that the pressing portion may be formed in the case 120.

Referring to FIG. 8, the buffer pad 840 may include a first buffer pad 840_1 that is greater than whichever of the first electrode and the second electrode that has a smallest planar size and less than a planar size of a plane delimited by borders of the inner surface of the case 120, and/or a second buffer pad 840_2 that is greater than whichever of the first electrode and the second electrode that has the smallest planar size and less than the planar size of the plane delimited by the borders of the inner surface of the case 120.

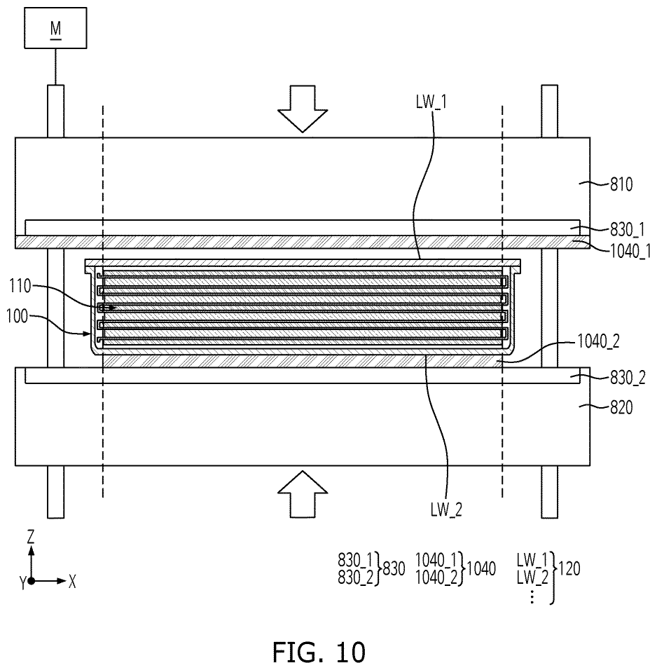

Referring to FIG. 10, a buffer pad 1040 may include a first buffer pad 1040_1 disposed on the bottom of the first heat pressing plate 810 and/or a second buffer pad 1040_2 having a greater planar size than whichever of the first electrode and the second electrode that has the smallest planar size and a smaller planar size than the planar size of the plane delimited by the borders of the inner surface of the case 120.

The buffer pads 840 and 1040 may include a silicone-based or polytetrafluoroethylene-based polymer with excellent heat resistance and an excellent buffering effect to prevent damage at a bonding part of the case, allowing the electrode assembly to be uniformly pressed.

When the electrode assembly is a stacked-type electrode assembly, a planar size of the cell pad may be greater than whichever of a first electrode and a second electrode that has a smallest planar size, and less than a planar size of a plane delimited by borders of the inner surface of the case.

The cell pad may be attached onto the first longitudinal side wall LW_1 or the second longitudinal side wall LW_2 of the secondary battery 100. Accordingly, the cell pad may overlap with a buffer pad disposed on the bottom of the first heat pressing plate 810 or the top of the second heat pressing plate 820 during the heat pressing process.

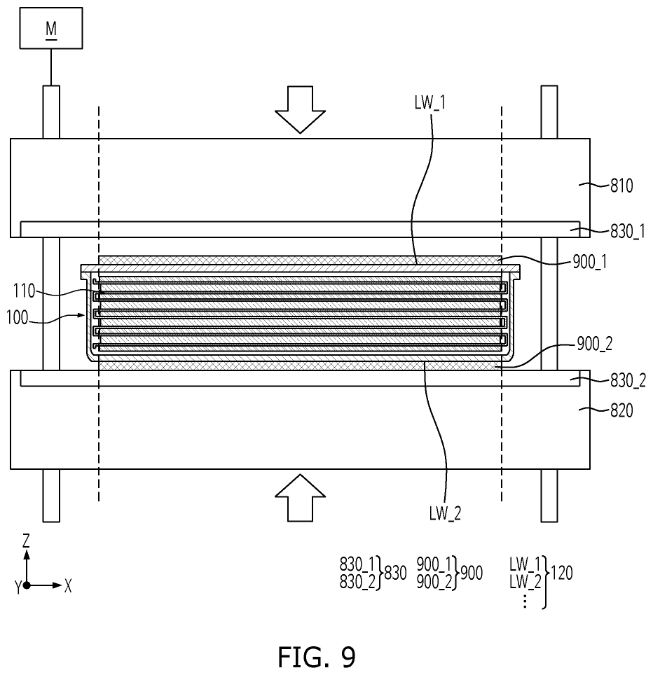

Referring to FIG. 9, a cell pad 900 may include a first cell pad 900_1 attached or fixed to the first longitudinal side wall LW_1, and the first cell pad 900_1 may be greater than whichever of a first electrode and a second electrode of the electrode assembly 110 that has a smallest planar size and less than a planar size of a plane delimited by borders of the inner surface of the case 120. The cell pad 900 may also include a second cell pad 900_2 attached or fixed to the second longitudinal side wall LW_2, and the second cell pad 900_2 may be greater than whichever of a first electrode and a second electrode of the electrode assembly 110 that has a smallest planar size and less than a planar size of a plane delimited by borders of the inner surface of the case 120.

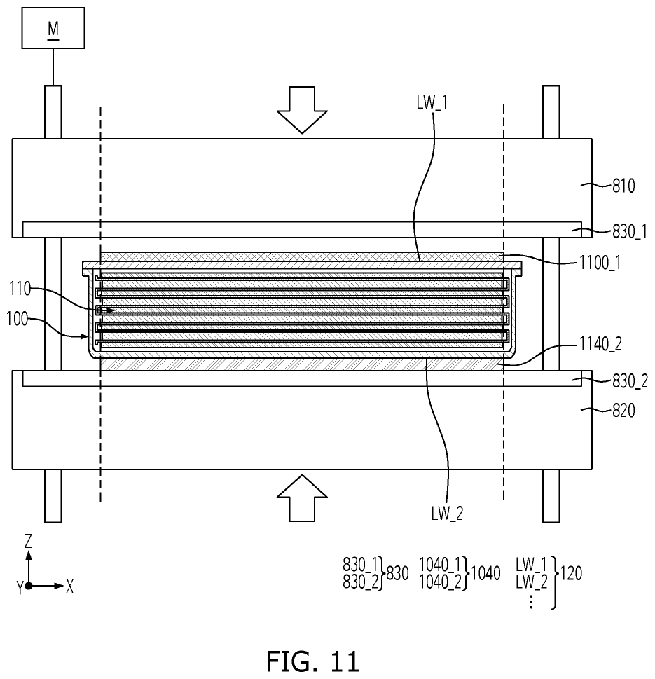

Referring to FIG. 11, a buffer pad may be arranged so as to not be on the bottom of the first heat pressing plate 810. A second buffer pad 1140_2 that is greater than whichever of a first electrode and a second electrode that has a smallest planar size and less than the planar size of the plane delimited by the borders of the inner surface of the case may be disposed on an upper surface of the second heat pressing plate 820. In addition, a first cell pad 1100_1 may be attached or fixed to the first longitudinal side wall LW_1 and may be greater than whichever of the first electrode and the second electrode of the electrode assembly 110 that has a smallest planar size and less than the planar size of the plane delimited by the borders of the inner surface of the case.

When the electrode assembly is a wound-type electrode assembly, a planar size of the buffer pad may be greater than at least one of the upper planar portion and the lower planar portion, as described above with respect to the size of the pressing portion in FIG. 4, and less than the planar size of the plane delimited by the borders of the inner surface of the case.

When the electrode assembly is a wound-type electrode assembly, the planar size of the cell pad may be greater than at least one of the upper planar portion and the lower planar portion, as described above with respect to the size of the pressing portion in FIG. 4, and less than the planar size of the plane delimited by the borders of the inner surface of the case.

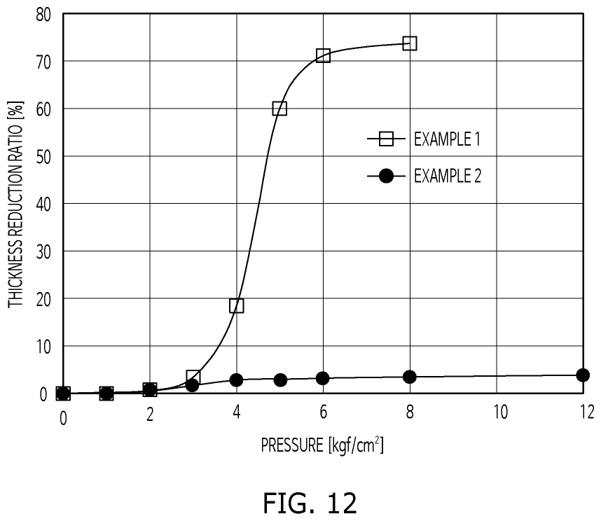

FIG. 12 is a graph illustrating a thickness reduction ratio of a secondary battery according to pressing pressure conditions of a heat pressing method according to some embodiments of the present disclosure. Particularly, FIG. 12 shows a thickness reduction ratio based on pressure conditions, allowing insight into a pressure at which the thickness reduction ratio starts to reduce.

Example 1 illustrates a cell without an electrode assembly accommodated inside a case (thickness: about 0.1 mm) made of stainless steel, and Example 2 illustrates a cell identical to Example 1, but with an electrode assembly being inserted in the cell and being 30% charged (i.e., state of charge [SOC]).

Referring to FIG. 12, when the heat pressing process is performed in Example 1, a thickness of the case may start to decrease at a pressure of 2 kgf/cm2 and may rapidly decrease starting from a pressure of 3kgf/cm2 . When a heat-pressing process is performed in Example 2, the thickness of the case may start to decrease at the pressure of 3kgf/cm2 , and as the electrode assembly is pressed at a pressure greater than 3kgf/cm2 , the thickness of the case may stably decrease by approximately 3.8% to 12 kgf/cm2. According to the Example 1 and 2, a pressure of about 12 kgf/cm2 or less may be an appropriate pressure for forming a pressing portion on a case made of stainless steel with a thickness of about 0.1 mm.

Although the present disclosure has been described above with respect to some embodiments disclosed above, the present disclosure is not limited to the above-described embodiments. Various modifications and variations can be made to the above-described embodiments by those skilled in the art.

### DESCRIPTION OF NOTATIONS

100: Secondary Battery
410: Electrode Assembly
120: Case

What is claimed is:

1. A secondary battery comprising:
an electrode assembly comprising a first electrode, a second electrode, and a separator disposed between the first electrode and the second electrode; and
a case comprising:
a body having one open surface to accommodate the electrode assembly; and
a cover sealing the one open surface of the body, the cover pressing and fixing the electrode assembly,
wherein a pressing portion recessed toward the electrode assembly is formed at a bottom of the body or a surface of the cover.

2. The secondary battery as claimed in claim 1, wherein a material of the case comprises stainless use steel.

3. The secondary battery as claimed in claim 2, wherein a thickness of the case is from about 0.05 mm to about 0.2 mm.

4. The secondary battery as claimed in claim 1, wherein the electrode assembly is a stacked-type electrode assembly formed by alternately stacking a first unit cell, in which the first electrode and the separator are stacked, and a second unit cell, in which the second electrode and the separator are stacked, and
wherein a planar size of the pressing portion is greater than a planar size of a smallest electrode of a group consisting of the first electrode and the second electrode, and is less than a planar size of a plane delimited by borders of an inner surface of the body.

5. The secondary battery as claimed in claim 4, wherein a direction in which the case presses the electrode assembly is a stacking direction of the first electrode, the separator, and the second electrode.

6. The secondary battery as claimed in claim 1, wherein the electrode assembly is a wound-type electrode assembly comprising an upper planar portion, a lower planar portion, and a curved portion connected to a side surface of the upper planar portion and the lower planar portion, and
wherein a planar size of the pressing portion is greater than the upper planar portion or the lower planar portion and is less than a planar size of a plane delimited by borders of an inner surface of the body.

7. The secondary battery as claimed in claim 6, wherein a direction in which the case presses the electrode assembly is a stacking direction of the first electrode, the separator, and the second electrode, which are stacked between the upper planar portion and the lower planar portion.

8. The secondary battery as claimed in claim 1, wherein the pressing portion comprises a first pressing portion formed on the bottom of the body and a second pressing portion formed on the surface of the cover, and
wherein a minimum length in a Z-direction between the first pressing portion and the second pressing portion is from about 90% to about 99% of a maximum length in the Z-direction between the bottom of the body and an outer surface of the cover.

9. The secondary battery as claimed in claim 1, wherein the electrode assembly further comprises an adhesive layer comprising a material of polyvinylidene fluoride series or a material of acrylate series positioned between the separator and the first electrode or between the separator and the second electrode.

10. The secondary battery as claimed in claim 9, wherein the adhesive layer further comprises a ceramic material.

11. The secondary battery as claimed in claim 9, wherein the electrode assembly further comprises a ceramic layer between the adhesive layer and the separator.

12. A method of heat pressing a secondary battery, the method comprising:
preparing a first heat pressing plate and a second heat pressing plate by spacing the first heat pressing plate and the second heat pressing plate apart from each other by a predetermined distance and by attaching a buffer pad onto a surface of the first heat pressing plate or a surface of the second heat pressing plate;
arranging a secondary battery between the first heat pressing plate and the second heat pressing plate; and
heating and pressing the secondary battery with the first heat pressing plate and the second heat pressing plate.

13. The method as claimed in claim 12, further comprising, before the arranging, attaching a cell pad, having a size corresponding to an electrode assembly, to a first longitudinal side wall or a second longitudinal side wall of a case of the secondary battery, the first longitudinal side wall and the second longitudinal side wall facing each other.

14. The method as claimed in claim 13, further comprising:
providing the electrode assembly so that the electrode assembly is a stacked-type electrode assembly formed by alternately stacking a first unit cell, in which a first electrode and a separator are stacked, and a second unit cell, in which a second electrode and the separator are stacked; and
providing the cell pad such that a planar size of the cell pad is greater than a planar size of a smallest electrode of a group consisting of the first electrode and the second electrode and is less than a planar size of a plane delimited by borders of an inner surface of the case.

15. The method as claimed in claim 13, further comprising:
providing the electrode assembly so that the electrode assembly is a wound-type electrode assembly comprising an upper planar portion, a lower planar portion, and a curved portion connected to side surfaces of the upper planar portion and the lower planar portion; and
providing the cell pad so that a planar size of the cell pad is greater than the upper planar portion or the lower planar portion and is less than a planar size of a plane delimited by borders of an inner surface of the case.

16. The method as claimed in claim 12, further comprising:
providing an electrode assembly that is a stacked-type electrode assembly formed by alternately stacking a first unit cell, in which a first electrode and a separator are stacked, and a second unit cell, in which a second electrode and the separator are stacked; and
configuring a planar size of the buffer pad to be greater than a planar size of a smallest electrode of a group consisting of the first electrode and the second electrode and to be less than a planar size of a plane delimited by borders of an inner surface of a case of the secondary battery.

17. The method as claimed in claim 12, further comprising:
providing an electrode assembly that is a wound-type electrode assembly comprising an upper planar portion, a lower planar portion, and a curved portion connected to side surfaces of the upper planar portion and the lower planar portion; and
configuring a planar size of the buffer pad to be greater than the upper planar portion or the lower planar portion and to be less than a planar size of a plane delimited by borders of an inner surface of a case of the secondary battery.

18. A heat pressing apparatus of a secondary battery, the heat pressing apparatus comprising:
a first heat pressing plate comprising a first heater;
a second heat pressing plate comprising a second heater and being spaced apart from a bottom of the first heat pressing plate by a predetermined distance;
a buffer pad arranged on a surface of the first heat pressing plate or a surface of the second heat pressing plate; and
a driving part pressing a case of a secondary battery by moving the first heat pressing plate or the second heat pressing plate toward the case, which is between the first heat pressing plate and the second heat pressing plate.

19. The heat pressing apparatus as claimed in claim 18, wherein an electrode assembly is a stacked-type electrode assembly formed by alternately stacking a first unit cell, in which a first electrode and a separator are stacked, and a second unit cell, in which a second electrode and the separator are stacked, and
wherein a planar size of the buffer pad is greater than a planar size of a smallest electrode of a group consisting of the first electrode and the second electrode and is less than a planer size of a plane delimited by borders of an inner surface of the case.

20. The heat pressing apparatus as claimed in claim 18, wherein an electrode assembly is a wound-type electrode assembly comprising an upper planar portion, a lower planar portion, and a curved portion connected to side surfaces of the upper planar portion and the lower planar portion, and
wherein a planar size of the buffer pad is greater than the upper planar portion or the lower planar portion and is less than a planar size of a plane delimited by borders of an inner surface of the case.
